(19) United States
(12) Patent Application Publication
(10) Pub. No.: US 2023/0057235 A1
(43) Pub. Date: Feb. 23, 2023

(54) COMPUTER-READABLE RECORDING MEDIUM STORING DETERMINATION PROGRAM, DETERMINATION DEVICE, AND DETERMINATION METHOD

(71) Applicant: FUJITSU LIMITED, Kawasaki-shi (JP)

(72) Inventor: Akiyoshi Uchida, Akashi (JP)

(73) Assignee: FUJITSU LIMITED, Kawasaki-shi (JP)

(21) Appl. No.: 17/979,885

(22) Filed: Nov. 3, 2022

Related U.S. Application Data
(63) Continuation of application No. PCT/JP2020/025736, filed on Jun. 30, 2020.

(51) Int. Cl. G06V 40/16; G06V 10/24; G06V 10/774

(52) U.S. Cl. CPC G06V 40/174; G06V 10/24; G06V 10/774

(57) ABSTRACT

A non-transitory computer-readable recording medium stores a determination program for causing a computer to execute processing including: acquiring a group of captured images that include a face to which markers are attached; calculating a first vector based on positions of the markers included in the captured images; dividing the first vector into a second vector according to a determination direction of a first action unit associated with the markers and a third vector according to a determination direction of a second action unit associated with the markers; and determining first occurrence intensity of the first action unit and second occurrence intensity of the second action unit based on the second vector and the third vector.

### CROSS-REFERENCE TO RELATED APPLICATION

This application is a continuation application of International Application PCT/JP2020/025736 filed on Jun. 30, 2020 and designated the U.S., the entire contents of which are incorporated herein by reference.

### FIELD

The present embodiment relates to a determination technology.

### BACKGROUND

Facial expressions play an important role in nonverbal communication. Estimation of facial expressions is an essential technology for developing computers that understand people and assist the people. In order to estimate facial expressions, it is first needed to specify a method of describing facial expressions. An action unit (AU) is known as the method of describing facial expressions. AUs are facial movements related to expression of facial expressions, defined based on anatomical knowledge of facial muscles, and technologies for estimating the AUs have also been proposed so far.

Related art is disclosed in Japanese Laid-open Patent Publication No. 2011-237970 and X. Zhang, L. Yin, J. Cohn, S. Canavan, M. Reale, A. Horowitz, P. Liu, and J. M. Girard. BP4D-spontaneous: A high-resolution spontaneous 3d dynamic facial expression database. Image and Vision Computing, 32, 2014. 1

### SUMMARY

According to an aspect of the embodiments, a non-transitory computer-readable recording medium stores a determination program for causing a computer to execute processing including: acquiring a group of captured images that include a face to which markers are attached; calculating a first vector based on positions of the markers included in the captured images; dividing the first vector into a second vector according to a determination direction of a first action unit associated with the markers and a third vector according to a determination direction of a second action unit associated with the markers; and determining first occurrence intensity of the first action unit and second occurrence intensity of the second action unit based on the second vector and the third vector.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example of a determination system according to the present embodiment.

FIG. 2 is a diagram illustrating an example of arrangement of cameras according to the present embodiment.

FIGS. 3A to 3C are a diagram illustrating an example of movements of markers according to the present embodiment.

FIG. 4 is a diagram illustrating an example of a determination method of occurrence intensity according to the present embodiment.

FIG. 5 is a diagram illustrating an example of the determination method of the occurrence intensity according to the present embodiment.

FIG. 6 is a diagram illustrating an example of a movement vector relative to a regulation vector according to the present embodiment.

FIG. 7 is a diagram illustrating an example of regulation vectors of a plurality of AUs corresponding to one marker according to the present embodiment.

FIG. 8 is a diagram illustrating an example of conflicting regulation vectors of a plurality of AUs corresponding to one marker according to the present embodiment.

FIG. 9 is a block diagram illustrating a configuration example of a determination device according to the present embodiment.

FIG. 10 is a diagram illustrating an example of a division method of the movement vector according to the present embodiment.

FIG. 11 is a diagram illustrating an example of distortion of a position of a marker according to the present embodiment.

FIGS. 12A to 12C are a diagram illustrating an example of a generation method of a mask image for removing the markers according to the present embodiment.

FIG. 13 is a diagram illustrating an example of a marker removal method according to the present embodiment.

FIG. 14 is a flowchart illustrating an example of a flow of determination processing according to the present embodiment.

FIG. 15 is a diagram illustrating a hardware configuration example of the determination device according to the present embodiment.

### DESCRIPTION OF EMBODIMENTS

A representative form of an AU estimation engine that estimates AUs is based on machine learning based on a large volume of training data, and image data of facial expressions and occurrence (presence or absence of occurrence) and intensity (occurrence intensity) of each AU are used as the training data. Furthermore, occurrence and intensity of the training data are subjected to annotation by a specialist called a coder.

However, existing methods have a problem that it may be difficult to generate training data for AU estimation. For example, since annotation by a coder is costly and time-consuming, it is difficult to create a large volume of data. Furthermore, in movement measurement of each facial part based on image processing of facial images, it is difficult to accurately capture small changes, and it is difficult for a computer to make AU determination from the facial images without human judgment. Therefore, it is difficult for the computer to generate training data in which AU labels are attached to the facial images without human judgment.

In one aspect, it is an object to generate training data for AU estimation.

Hereinafter, examples of a determination program, a determination device, and a determination method according to the present embodiment will be described in detail with reference to the drawings. Note that the present embodiment is not limited by the examples. Furthermore, the individual examples may be appropriately combined within a range without inconsistency.

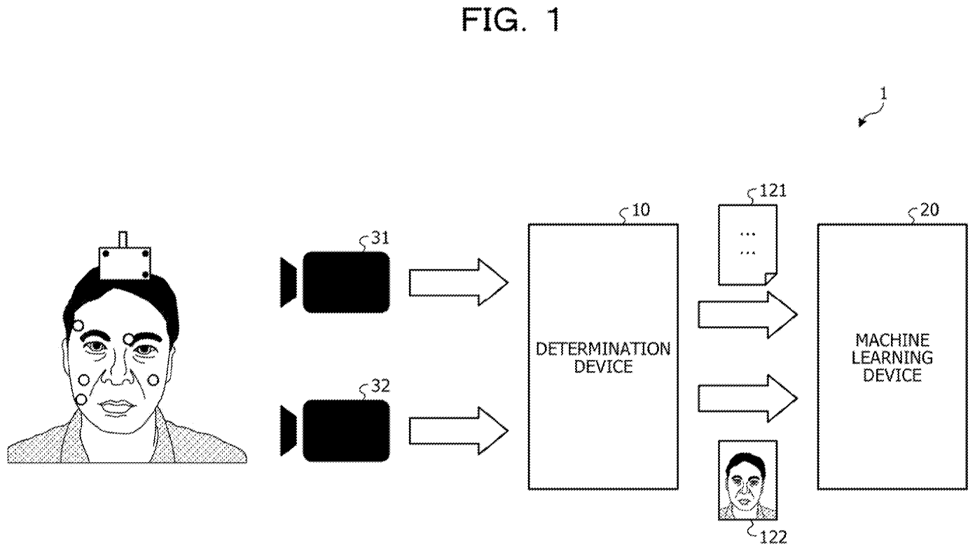

A configuration of a determination system according to the present embodiment will be described with reference to FIG. 1. FIG. 1 is a diagram illustrating the configuration of the determination system according to the present embodiment. As illustrated in FIG. 1, a determination system 1 includes a red green blue (RGB) camera 31, an infrared (IR) camera 32, a determination device 10, and a machine learning device 20.

As illustrated in FIG. 1, first, the RGB camera 31 and the IR camera 32 are oriented toward a face of a person to which markers are attached. For example, the RGB camera 31 is a common digital camera, which receives visible light and generates an image. Furthermore, for example, the IR camera 32 senses infrared rays. Furthermore, the markers are, for example, IR reflection (retroreflection) markers. The IR camera 32 may perform motion capture by using IR reflection by the markers. Furthermore, in the following description, a person to be captured will be referred to as a subject.

The determination device 10 acquires an image captured by the RGB camera 31, and a result of motion capture by the IR camera 32. Then, the determination device 10 determines occurrence intensity 121 of an AU, and outputs, to the machine learning device 20, the occurrence intensity 121 and an image 122 obtained by removing the markers from the captured image by image processing. For example, the occurrence intensity 121 may be data in which occurrence intensity of each AU is expressed by six-level evaluation using 0 to 1 and annotation such as “AU 1:2, AU 2:5, AU 4:0, . . . ” has been performed. Furthermore, the occurrence intensity 121 may be data in which occurrence intensity of each AU is expressed by 0, which means no occurrence, or by five-level evaluation of A to E and annotation such as “AU 1:B, AU 2:E, AU 4:0, . . . ” has been performed. Moreover, the occurrence intensity is not limited to be expressed by five-level evaluation and may be expressed by, for example, two-level evaluation (presence or absence of occurrence).

The machine learning device 20 performs machine learning by using the image 122 and the occurrence intensity 121 of an AU output from the determination device 10 and generates a model for calculating an estimated value of occurrence intensity of an AU from an image. The machine learning device 20 may use the occurrence intensity of an AU as a label. Note that the processing of the machine learning device 20 may be performed by the determination device 10. In this case, the machine learning device 20 does not have to be included in the determination system 1.

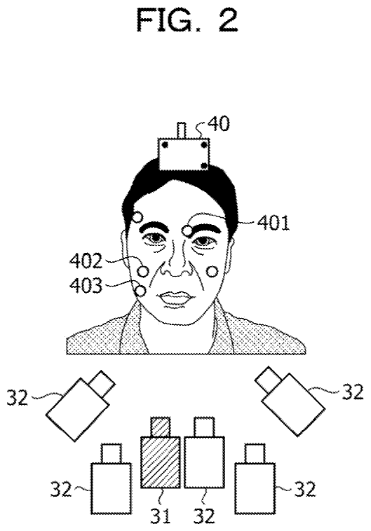

Here, arrangement of cameras will be described with reference to FIG. 2. FIG. 2 is a diagram illustrating an example of the arrangement of the cameras according to the present embodiment. As illustrated in FIG. 2, a plurality of the IR cameras 32 may configure a marker tracking system. In that case, the marker tracking system may detect positions of IR reflection markers by stereoscopic image capturing. Furthermore, it is assumed that a relative positional relationship between each of the plurality of IR cameras 32 is corrected by camera calibration.

Furthermore, a plurality of markers is attached to the face of the subject to be captured to cover target AUs (for example, an AU 1 to an AU 28). Positions of the markers change according to a change in a facial expression of the subject. For example, a marker 401 is arranged near a root of an eyebrow. Furthermore, a marker 402 and a marker 403 are arranged near a smile line. The markers may be arranged on skin corresponding to one or more AUs and movements of facial expression muscles. Furthermore, the markers may be arranged by avoiding positions on the skin where a change in texture is large due to wrinkling or the like.

Moreover, the subject wears an instrument 40 to which reference markers are attached. It is assumed that positions of the reference markers attached to the instrument 40 do not change even when a facial expression of the subject changes. Accordingly, the determination device 10 may detect a change in the positions of the markers attached to the face based on a change in the relative positions from the reference markers. Furthermore, the determination device 10 may specify coordinates of each marker on a plane or in a space based on the positional relationship with the reference marker. Note that the determination device 10 may determine the positions of the markers from a reference coordinate system, or may determine them from a projection position of a reference plane. Furthermore, by setting the number of reference markers to three or more, the determination device 10 may specify the positions of the markers in a three-dimensional space.

The instrument 40 is, for example, a headband, in which the reference markers are arranged outside a contour of the face. Furthermore, the instrument 40 may be a VR headset, a mask formed of a rigid material, or the like. In that case, the determination device 10 may use a rigid surface of the instrument 40 as the reference markers.

The determination device 10 determines presence or absence of occurrence of each of the plurality of AUs based on a determination criterion of the AUs and the positions of the plurality of markers. The determination device 10 determines occurrence intensity for one or more AUs occurred among the plurality of AUs.

For example, the determination device 10 determines occurrence intensity of a first AU based on a movement amount of a first marker calculated based on a distance between a reference position of the first marker associated with the first AU included in the determination criterion and a position of the first marker. Note that, it may be said that the first marker is one or a plurality of markers corresponding to a specific AU.

The determination criterion of the AUs indicates, for example, one or a plurality of markers used to determine, for each AU, occurrence intensity of the AU among the plurality of markers. The determination criterion of the AUs may include reference positions of the plurality of markers. The determination criterion of the AUs may include, for each of the plurality of AUs, a relationship (conversion rule) between occurrence intensity and a movement amount of a marker used to determine the occurrence intensity. Note that the reference positions of the markers may be determined according to each position of the plurality of markers in a captured image in which the subject is in an expressionless state (no AU has occurred).

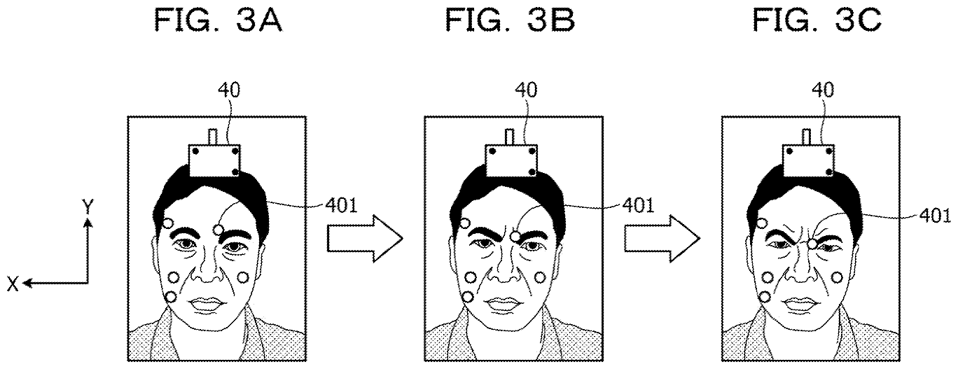

Here, movements of markers will be described with reference to FIGS. 3A to 3C. FIGS. 3A to 3C are is a diagram illustrating an example of the movements of the markers according to the present embodiment. In FIGS. 3A to 3C, FIGS. 3A to 3C are images captured by the RGB camera 31. Furthermore, it is assumed that the images are captured in the order of FIGS. 3A to 3C. For example, FIG. 3A is an image when the subject is expressionless. The determination device 10 may regard positions of the markers in the image FIG. 3A as reference positions where the movement amount is 0.

As illustrated in FIGS. 3A to 3C, the subject has a facial expression of pulling eyebrows together. At this time, the position of the marker 401 moves in a downward direction in accordance with the change in the facial expression. At that time, the distance between the position of the marker 401 and the reference marker attached to the instrument 40 is large.

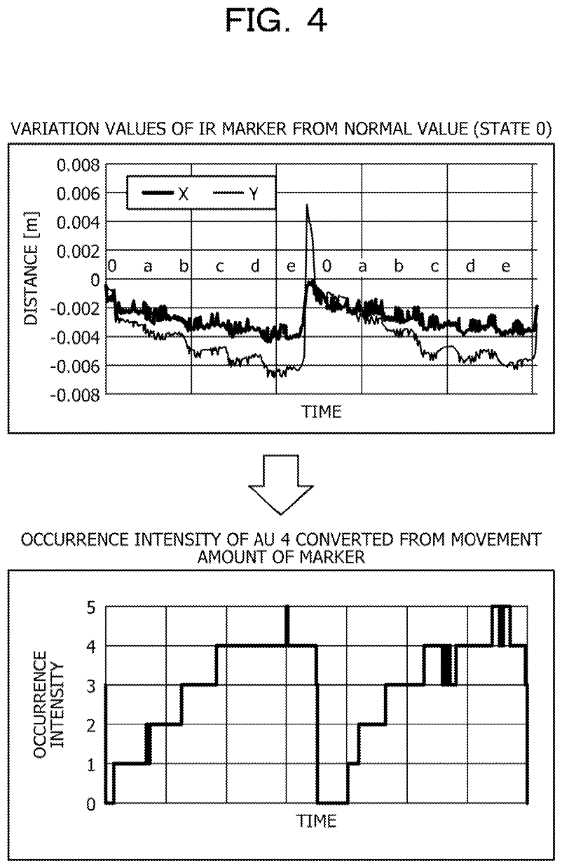

Furthermore, variation values in the distance from the reference marker of the marker 401 in an X direction and a Y direction are represented as in FIG. 4. FIG. 4 is a diagram illustrating an example of a determination method of occurrence intensity according to the present embodiment. As illustrated in FIG. 4, the determination device 10 may convert the variation values into occurrence intensity. Note that the occurrence intensity may be quantized in five levels according to a facial action coding system (FACS), or may be defined as a continuous amount based on a variation amount.

Various rules may be considered as a rule for the determination device 10 to convert the variation amount into the occurrence intensity. The determination device 10 may perform conversion in accordance with one determined rule, or may perform conversion according to a plurality of rules to adopt the one with the largest occurrence intensity.

For example, the determination device 10 may acquire the maximum variation amount, which is a variation amount when the subject changes the facial expression most, and may convert the occurrence intensity based on a ratio of the variation amount to the maximum variation amount. Furthermore, the determination device 10 may determine the maximum variation amount by using data tagged by a coder by an existing method. Furthermore, the determination device 10 may linearly convert the variation amount into the occurrence intensity. Furthermore, the determination device 10 may perform conversion by using an approximation expression created from preliminary measurement of a plurality of subjects.

Furthermore, for example, the determination device 10 may determine the occurrence intensity based on a movement vector of the first marker calculated based on the position set as the determination criterion and the position of the first marker. In this case, the determination device 10 determines the occurrence intensity of the first AU based on a degree of matching between the movement vector of the first marker and a regulation vector associated in advance with the first AU. Furthermore, the determination device 10 may correct correspondence between the magnitude of the vector and the occurrence intensity by using an existing AU estimation engine.

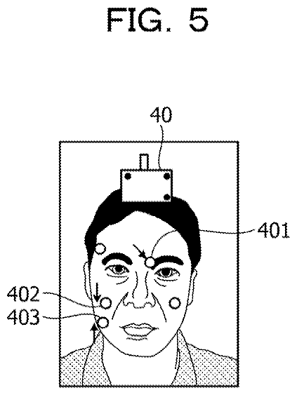

The determination method of the occurrence intensity of the AU will be described more specifically. FIG. 5 is a diagram illustrating an example of the determination method of the occurrence intensity according to the present embodiment. For example, it is assumed that a regulation vector corresponding to an AU 4 is determined as (X, Y)=(−2 mm, −6 mm). At this time, the determination device 10 calculates an inner product of a movement vector of the marker 401 and the regulation vector, and normalizes the inner product by the magnitude of the regulation vector. Here, when the inner product matches the magnitude of the regulation vector of the AU 4, the determination device 10 determines occurrence intensity of the AU 4 as 5 out of the five levels. On the other hand, when the inner product is a half of the regulation vector of the AU 4, for example, in the case of the linear conversion rule described above, the determination device 10 determines the occurrence intensity of the AU 4 as 3 out of the five levels.

Furthermore, for example, in FIG. 5, it is assumed that the magnitude of a regulation vector corresponding to an AU 11 is determined as 3 mm. At this time, when a variation amount in a distance between the marker 402 and the marker 403 matches the magnitude of the regulation vector of the AU 11, the determination device 10 determines occurrence intensity of the AU 11 as 5 out of the five levels. On the other hand, when the variation amount in the distance is a half of the regulation vector of the AU 11, for example, in the case of the linear conversion rule described above, the determination device 10 determines the occurrence intensity of the AU 11 as 3 out of the five levels. In this manner, the determination device 10 may determine the occurrence intensity based on the change in the distance between a position of a first marker and a position of a second marker.

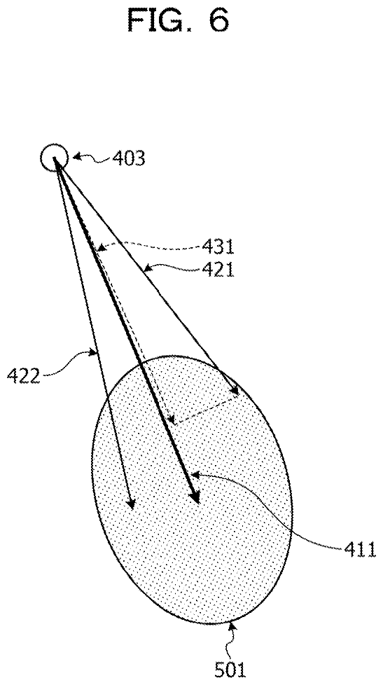

Incidentally, a movement vector of each marker may be dispersed and may not completely match a determination direction of a regulation vector. FIG. 6 is a diagram illustrating an example of the movement vector relative to the regulation vector according to the present embodiment. In the example of FIG. 6, a regulation vector 411 of the AU 4 associated with the marker 403 and movement vectors 421 and 422 of the marker 403 are illustrated.

As illustrated in FIG. 6, for example, there is deviation in directions indicated by the movement vectors 421 and 422 of the marker 401 relative to the regulation vector 411 of the AU 4. As an example only, the movement vectors of the markers 401 may be dispersed in this manner within a dispersion range 501.

However, even when the movement vectors are dispersed, occurrence intensity of an AU corresponding to the regulation vector may be determined by calculating an inner product of the movement vector and the regulation vector. In FIG. 6, an inner product 431 is an inner product of the movement vector 421 and the regulation vector 411. As described specifically with reference to FIG. 5, the occurrence intensity of the AU 4 corresponding to the regulation vector 411 may be determined by the inner product 431. Note that, although the inner product 431 is indicated slightly shifted from the regulation vector 411 in FIG. 6 for convenience, they actually overlap.

An example in which one AU is associated with one marker has been described above. However, a plurality of AUs may be associated with one marker. That is, in a case where facial expression determination is estimated based on a movement of a specific part (movement amount of a single marker), there are a part that contributes only to a single AU and a part that is related to a plurality of AUs. Since the part (marker) related to the plurality of AUs is used for estimation of occurrence intensity of the plurality of AUs, the plurality of AUs is associated with one marker.

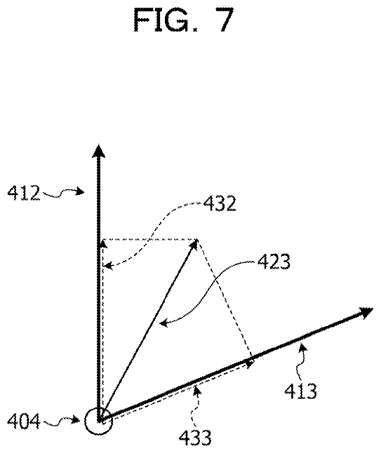

FIG. 7 is a diagram illustrating an example of regulation vectors of a plurality of AUs corresponding to one marker according to the present embodiment. In the example of FIG. 7, regulation vectors 412 and 413 of two AUs associated with the same marker 404 are illustrated. Furthermore, a movement vector 423 of the marker 404 is illustrated. In a case where a movement vector is generated along only one of the regulation vector 412 or the regulation vector 413, either one AU is generated. On the other hand, the movement vector 423 is a movement vector in a case where two AUs are simultaneously generated due to a facial expression of a subject.

Even in the case where two AUs are simultaneously generated in this manner, occurrence intensity of each AU may be determined by calculating inner products 432 and 433 with the movement vector 423 for the regulation vectors 412 and 413 of the respective AUs, respectively.

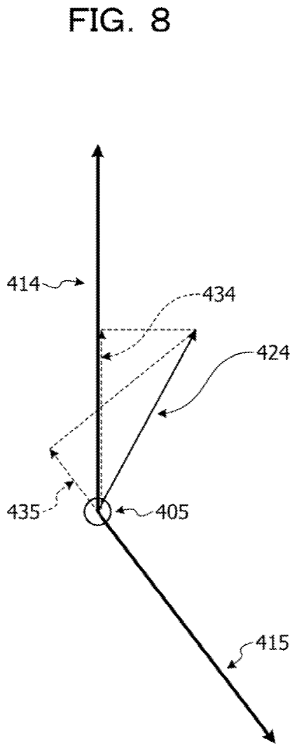

However, for movements of some parts, conflicting movements may be indicated in the determination of occurrence intensity of AUs. That is, in a case where regulation vectors of simultaneously generated AUs conflict with each other, occurrence intensity of the AUs may not be correctly determined by inner products with the movement vector. Here, when the regulation vectors are conflict with each other, for example, the two regulation vectors have opposite components at least in an x-axis direction or a y-axis direction. FIG. 8 is a diagram illustrating an example of conflicting regulation vectors of a plurality of AUs corresponding to one marker according to the present embodiment. In the example of FIG. 8, regulation vectors 414 and 415 of two AUs associated with a marker 405 are illustrated. Furthermore, a movement vector 424 of the marker 405 is illustrated. The movement vector 424 is a movement vector in a case where two AUs are simultaneously generated due to a facial expression of a subject.

As illustrated in FIG. 8, when inner products 434 and 435 with the movement vector 424 are calculated for the conflicting regulation vectors 414 and 415, respectively, the inner product 435 becomes negative relative to the corresponding regulation vector 415. Therefore, although occurrence intensity of an AU with the regulation vector 414 as the determination direction may be determined as 2, for example, occurrence intensity of an AU with the regulation vector 415 as the determination direction, in which the inner product becomes 0 or less, is determined to be 0, and the determination may not be made correctly. Thus, the determination device 10 according to the present embodiment correctly determines occurrence intensity of each AU even when regulation vectors corresponding to the same marker conflict with each other.

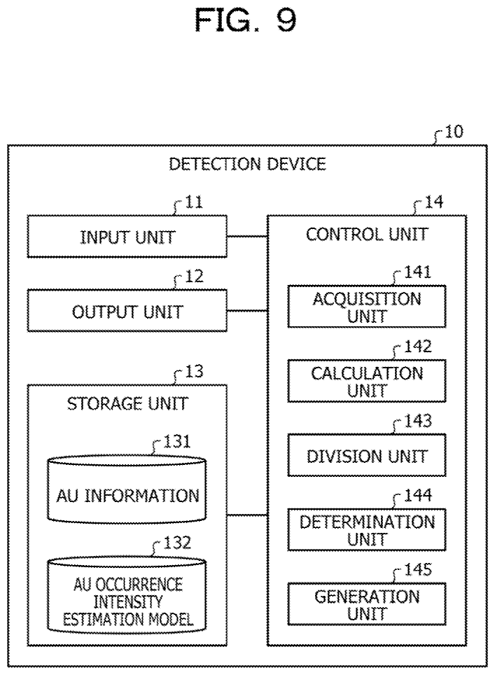

A functional configuration of the determination device 10 according to the present embodiment will be described with reference to FIG. 9. FIG. 9 is a block diagram illustrating a configuration example of the determination device. As illustrated in FIG. 9, the determination device 10 includes an input unit 11, an output unit 12, a storage unit 13, and a control unit 14.

The input unit 11 is an interface for inputting data. For example, the input unit 11 receives an input of data via input devices such as the RGB camera 31, the IR camera 32, a mouse, and a keyboard. For example, an image captured by the RGB camera 31 and a result of motion capture by the IR camera 32 are input. Furthermore, the output unit 12 is an interface for outputting data. For example, the output unit 12 outputs data to an output device such as a display. For example, the occurrence intensity 121 of an AU and the image 122 obtained by removing markers from a captured image by image processing are output.

The storage unit 13 is an example of a storage device that stores data and a program or the like executed by the control unit 14, and is, for example, a hard disk, a memory, or the like. The storage unit 13 stores AU information 131 and an AU occurrence intensity estimation model 132.

The AU information 131 is information representing a correspondence relationship between markers and AUs. For example, a reference position of each marker, one or a plurality of AUs corresponding to each marker, and a direction and magnitude of a regulation vector of each AU are stored in association with each other.

The AU occurrence intensity estimation model 132 stores a model generated by machine learning with a captured image from which markers are removed as a feature and occurrence intensity of AUs including a plurality of AUs corresponding to one marker as a correct answer label.

The control unit 14 is a processing unit that controls the entire determination device 10, and includes an acquisition unit 141, a calculation unit 142, a division unit 143, a determination unit 144, and a generation unit 145.

The acquisition unit 141 acquires a captured image including a face. For example, the acquisition unit 141 acquires a group of captured images that are continuously captured and include a face of a subject to which markers are attached to a plurality of reference positions corresponding to a plurality of AUs. The captured images acquired by the acquisition unit 141 are captured by the RGB camera 31 and the IR camera 32 as described above.

Here, when an image is captured by the RGB camera 31 and the IR camera 32, the subject changes facial expressions. At this time, the subject may change the facial expressions freely, or may change the facial expressions according to a determined scenario. With this configuration, the RGB camera 31 and the IR camera 32 may capture, as the images, how the facial expressions change in time series. Furthermore, the RGB camera 31 may also capture a moving image. In other words, the moving image may be regarded as a plurality of still images arranged in time series.

The calculation unit 142 calculates a movement vector based on a position of a marker included in a captured image. For example, the calculation unit 142 derives a movement amount and a movement direction of the marker moved by a change in a facial expression of a subject from a reference position of the marker in the captured image.

Furthermore, the calculation unit 142 may also correct distortion of the position of the marker caused by skin and muscles of a face, and calculate the movement vector based on the corrected position of the marker. The distortion correction of the position of the marker will be described later.

Furthermore, in a case where there is one AU associated with the marker, the calculation unit 142 calculates an inner product of the movement vector and a regulation vector indicating a determination direction of the AU associated with the marker.

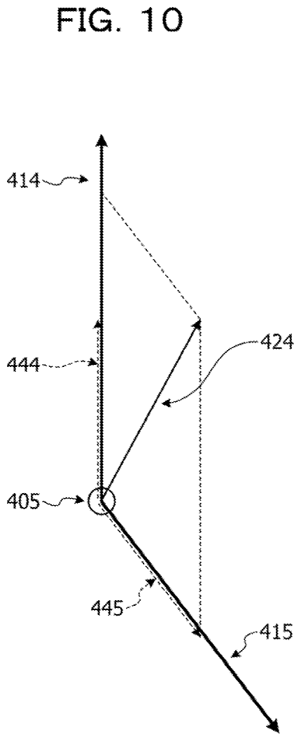

The division unit 143 divides, in a case where there is a plurality of AUs associated with a marker, a movement vector into a plurality of vectors according to determination directions of the respective AUs associated with the marker. FIG. 10 is a diagram illustrating an example of a division method of the movement vector according to the present embodiment. The movement vector 424 is a movement vector in a case where two AUs with the regulation vectors 414 and 415 associated with the marker 405 as determination directions are simultaneously generated, like the one illustrated in FIG. 8. The division unit 143 divides the movement vector 424 into division vectors 444 and 445 corresponding to the regulation vectors 414 and 415, respectively.

The division of the movement vector may be calculated by using the following Expression (1), based on the fact that the movement vector is a linear sum of the respective regulation vectors.

### Expression 1

$$( \begin{matrix}X \\ Y\end{matrix} ) = α ( \begin{matrix}Xa \\ Ya\end{matrix} ) + β ( \begin{matrix}Xb \\ Yb\end{matrix} ) \qquad ( 1 )$$

Here, (X, Y) in Expression (1) is a two-dimensional coordinate of the movement vector, (Xa, Ya) and (Xb, Yb) are two-dimensional coordinates of the respective regulation vectors, and α and β are linear coefficients of the respective regulation vectors. Note that, in a case where there are three or more AUs associated with the marker, the two-dimensional coordinates of the regulation vectors to be added in Expression (1) are increased as (Xc, Yc), (Xd, Yd), . . . , and the respective linear coefficients are also increased as y, σ, . . . .

The division unit 143 may convert Expression (1) into, for example, the following Expression (2) to calculate the linear coefficients α and β.

### Expression 2

$$( \begin{matrix}α \\ β\end{matrix} ) = {( \begin{matrix}Xa & Xb \\ Ya & Yb\end{matrix} )}^{- 1} ( \begin{matrix}X \\ Y\end{matrix} ) \qquad ( 2 )$$

In the example of FIG. 10, it is assumed that a two-dimensional coordinate of the regulation vector 414 is (0, 10), a two-dimensional coordinate of the regulation vector 415 is (2.4, −9.7), and a two-dimensional coordinate of the movement vector 424 is (1.5, 4.2). In this case, the division unit 143 may substitute each value into Expressions (1) and (2) to calculate (α, β) as (1, 0.6). Furthermore, based on (α, β)=(1, 0.6), the determination unit 144 may determine that occurrence intensity of the regulation vector 414 is 5 and occurrence intensity of the regulation vector 415 is 3.

The determination unit 144 determines, based on each regulation vector, occurrence intensity of an AU corresponding to each, as described above. Furthermore, the determination unit 144 may also determine presence or absence of occurrence of an AU based not only on the occurrence intensity but also on whether a movement amount of a marker indicated by a movement vector or a division vector exceeds a predetermined threshold.

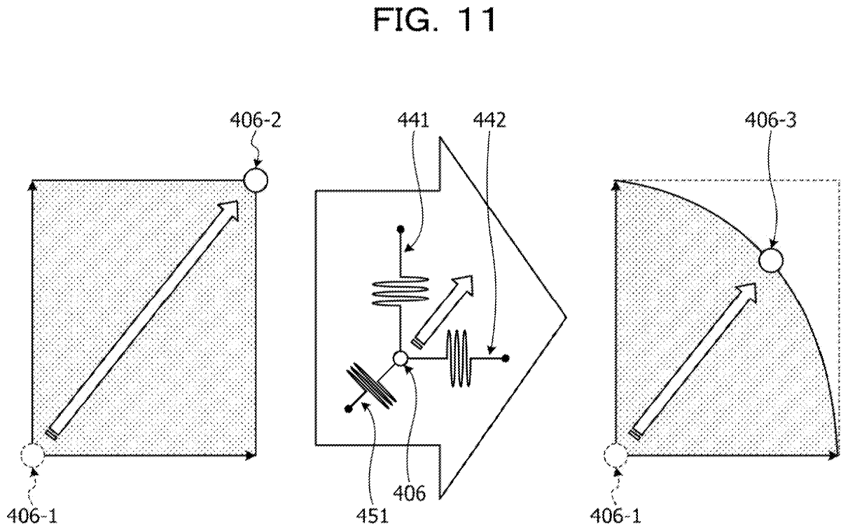

Although from the calculation of the movement vector to the determination of the occurrence intensity of an AU have been described above, distortion of the position of the marker caused by skin or muscles of a face may be corrected in order to perform the determination with higher accuracy. FIG. 11 is a diagram illustrating an example of distortion of a position of a marker according to the present embodiment.

In FIG. 11, a marker 406-1 is a position of a marker 406 when a subject is expressionless. As illustrated on a left side of FIG. 11, the marker 406 is movable within a rectangular range from the marker 406-1 to a marker 406-2 as the farthest positions, for example. However, actually, the movement of the marker 406 is restricted by skin and muscles of a face, and the marker 406 may only move within a fan-shaped range as illustrated on a right side of FIG. 11, for example. In this case, the position of the marker which is originally supposed to be a position of the marker 406-2 is subjected to movement restriction, and becomes, for example, a position of a marker 406-3.

More specifically, as illustrated in the center of FIG. 11, for example, the marker 406 is pulled in a direction of an arrow by facial expression muscles 441 and 442 when the subject changes a facial expression. On the other hand, the marker 406 is also pulled in an opposite direction by an anchor 451, which is another facial expression muscle or skin, and as a result, the movement is restricted. Such movement restriction of the position of the marker is referred to as distortion of the position of the marker. Thus, the determination device 10 according to the present embodiment corrects the distortion of the position of the marker, and then calculates the movement vector based on the corrected position of the marker. With this configuration, the determination device 10 may determine occurrence intensity and presence or absence of occurrence of an AU with higher accuracy.

The distortion correction of the position of the marker will be specifically described. The distortion correction of the position of the marker may be performed by using, for example, a mapping table between a position of the marker when distortion occurs and an original position of the marker. An example of the former distortion occurrence marker position is the position of the marker 406-3 in FIG. 11, and an example of the latter original position of the marker is the position of the marker 406-2. For the marker of a part where distortion occurs, each position of such a distortion occurrence marker position and an original position of the marker corresponding to each distortion occurrence marker position are set in the mapping table. Then, for the marker of the part where distortion occurs, the corresponding original position of the marker may be derived by calculating the distortion occurrence marker position from a movement amount of the position of the marker indicated by a movement vector and searching the mapping table. Note that, in a case where there is no data at the same position as the distortion occurrence marker position in the mapping table, data at a position closest to the distortion occurrence marker position may be searched for to derive the corresponding original position of the marker.

The mapping table may be created based on, for example, actual measurement data from a subject. More specifically, for example, a marker is attached to a face of the subject, and the subject is asked to make a specified facial expression, and movement amount data corresponding to each piece of facial expression data is created. Next, a coder is asked to annotate occurrence intensity of an AU based on the facial expression data. Then, a distortion occurrence marker position and an original position of the marker are derived from actual measurement data and an annotation result, respectively, and are set in the mapping table.

Furthermore, the distortion correction of the position of the marker may be performed by using, for example, a spring model generated by setting a spring constant for each of the facial expression muscles 441 and 442 and the anchor 451, as illustrated in the center of FIG. 11. In other words, by performing simulation in which force corresponding to a movement amount from a reference position of the marker to the original position of the marker is applied to the spring model, the distortion occurrence marker position may be obtained. Therefore, by applying appropriate force to the spring model to obtain the distortion occurrence marker position for which the original position of the marker is desired to be known, the original position of the marker may be derived based on the force applied at that time. Furthermore, by using this spring model to perform simulation for the original position of the marker, the mapping table described above may be created. Furthermore, the spring constant of the spring model may be appropriately adjusted according to a determination result of occurrence intensity of an AU by the determination device 10, or the like.

The generation unit 145 creates a data set in which a group of captured images and occurrence intensity of an AU are associated with each other. By performing machine learning using the data set, it is possible to generate the AU occurrence intensity estimation model 132, which is a model for calculating an estimated value of occurrence intensity of an AU from a group of captured images. Furthermore, the generation unit 145 removes markers from the group of captured images by image processing. The removal of the markers will be specifically described.

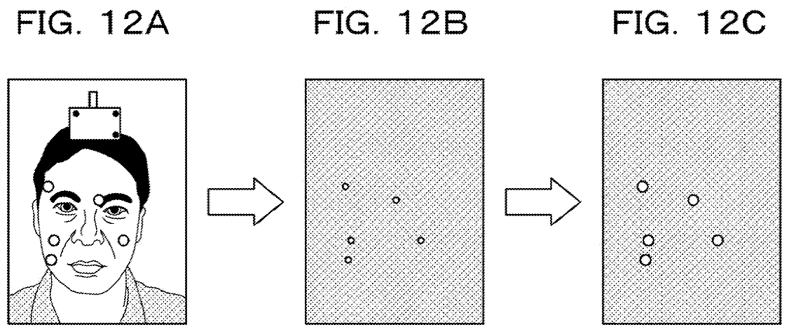

The generation unit 145 may remove markers by using a mask image. FIGS. 12A to 12C are an explanatory diagram for describing a generation method of a mask image for removing the markers according to the present embodiment. In FIGS. 12A to 12C, FIG. 12A is an image captured by the RGB camera 31. First, the generation unit 145 extracts a color of a marker intentionally attached, and defines the extracted color as a representative color. Then, as FIG. 12B in FIGS. 12A to 12C, the generation unit 145 generates an area image of a color in the vicinity of the representative color. Moreover, as in FIG. 12C in FIGS. 12A to 12C, the generation unit 145 performs processing such as contraction or expansion on the color area in the vicinity of the representative color, and generates a mask image for removing the markers. Furthermore, accuracy of extracting the color of the marker may be improved by setting the color of the marker to the color that hardly exists as the color of a face.

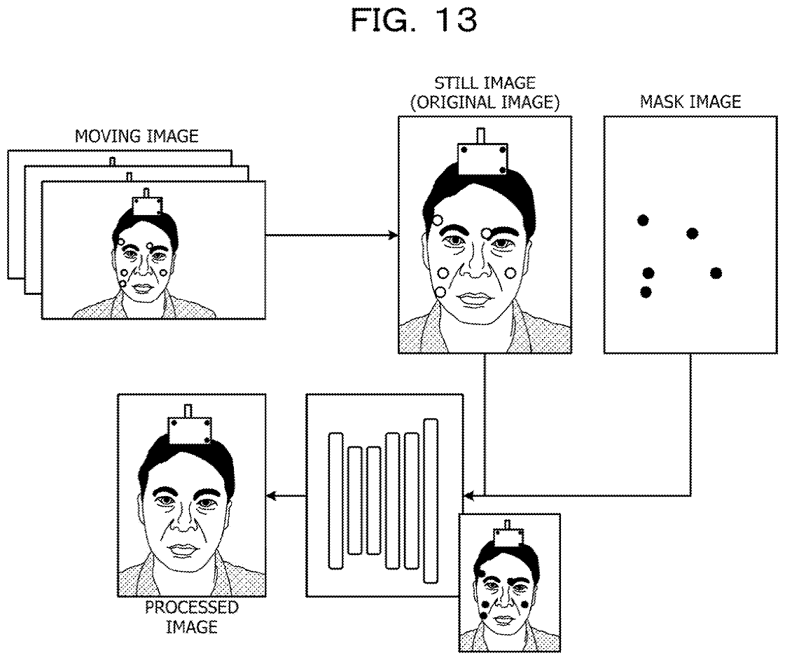

FIG. 13 is an explanatory diagram for describing a marker removal method according to the present embodiment. As illustrated in FIG. 13, first, the generation unit 145 applies a mask image to a still image acquired from a moving image. Moreover, the generation unit 145 inputs the image to which the mask image is applied to, for example, a neural network, and obtains a processed image. Note that it is assumed that the neural network has been trained by using an image of a subject with a mask, without a mask, or the like. Note that acquiring the still image from the moving image has an advantage that data in the middle of a change in the facial expression may be obtained and that a large volume of data may be obtained in a short time. Furthermore, the generation unit 145 may use generative multi-column convolutional neural networks (GMCNNs) or generative adversarial networks (GANs) as the neural network.

Note that the method of removing the markers by the generation unit 145 is not limited to the one described above. For example, the generation unit 145 may detect a position of a marker based on a determined shape of the marker to generate a mask image. Furthermore, the relative positions of the IR camera 32 and the RGB camera 31 may be preliminary calibrated. In this case, the generation unit 145 may detect the position of the marker from information of the marker tracking by the IR camera 32.

Furthermore, the generation unit 145 may adopt different detection methods depending on markers. For example, for a marker above a nose, since a movement is small and it is possible to easily recognize the shape, the generation unit 145 may detect the position by shape recognition. Furthermore, for a marker besides a mouth, since a movement is large and it is difficult to recognize the shape, the generation unit 145 may detect the position by a method of extracting the representative color.

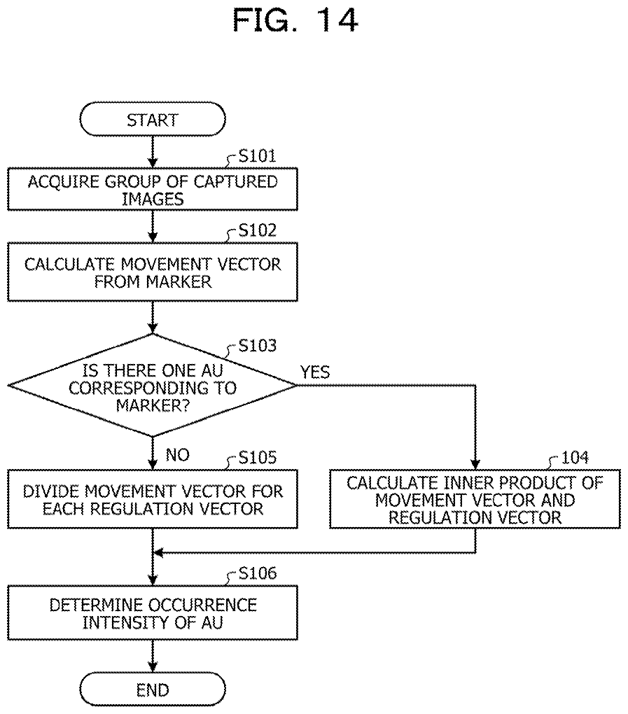

Next, a flow of determination processing of occurrence intensity of an AU by the determination device 10 will be described with reference to FIG. 14. FIG. 14 is a flowchart illustrating an example of a flow of the determination processing according to the present embodiment. As illustrated in FIG. 14, first, the acquisition unit 141 acquires a group of captured images including a face of a subject to which markers are attached to a plurality of reference positions corresponding to a plurality of AUs (Step S101).

Next, the calculation unit 142 calculates a movement vector based on positions of the marker included in the captured images acquired by the acquisition unit 141 (Step S102). Note that, for a marker of a part where distortion occurs, the distortion of a position of the marker is corrected, and then a movement vector is calculated.

Next, in a case where there is one AU corresponding to the marker used to calculate the movement vector (Step S103: Yes), the calculation unit 142 calculates an inner product of the movement vector and a regulation vector of the AU associated with the marker (Step S104).

On the other hand, in a case where there is two or more AUs corresponding to the marker used to calculate the movement vector (Step S103: No), the division unit 143 divides the movement vector into vectors of the respective AUs associated with the marker (Step S105).

Next, the determination unit 144 determines occurrence intensity of the corresponding AU based on the inner product with the regulation vector of the AU calculated in Step S104 or the division vectors of the respective AUs obtained by the division in Step S105 (Step S106). Specifically, in a case where the inner product of the movement vector and the regulation vector is calculated, the occurrence intensity of the AU may be determined by normalizing the inner product by the magnitude of the regulation vector. On the other hand, in a case where the movement vector is divided into the vectors corresponding to the respective AUs, the occurrence intensity of the AU may be determined by normalizing the vectors obtained by the division by the magnitude of the regulation vector. Note that, even when there is two or more AUs corresponding to the marker used to calculate the movement vector, in a case where the respective regulation vectors do not conflict with each other, inner products of the movement vector and regulation vectors of the AUs associated with the marker may be calculated (Step S104 is executed instead of Step S106). After Step S106, the determination processing illustrated in FIG. 14 ends.

Next, AU occurrence intensity estimation processing by using a model stored in the AU occurrence intensity estimation model 132 will be described. By inputting an image in which a face of a person to be estimated is captured into the model, occurrence intensity of one or a plurality of AUs is output. Markers need not be attached to the face of the person to be estimated. Furthermore, the model has been trained also for occurrence intensity of AUs in a case where a plurality of AUs is associated with the same marker and regulation vectors of the respective AUs conflict with each other. Therefore, by using the model, it is possible to correctly estimate occurrence intensity of AUs even for a facial expression in which a plurality of AUs with regulation vectors conflicting with each other is generated. Note that the model may be stored in a device other than the determination device 10, and may be used for the AU occurrence intensity estimation processing.

As described above, the determination device 10 acquires a group of captured images including a face to which markers are attached, calculates a movement vector as a first vector based on positions of the markers included in the captured images, divides the first vector into a division vector as a second vector according to a determination direction of a first AU associated with the markers and a division vector as a third vector according to a determination direction of a second AU associated with the markers, and determines first occurrence intensity of the first AU and second occurrence intensity of the second AU based on the second vector and the third vector.

With this configuration, the determination device 10 may correctly determine the occurrence intensity of each AU even when regulation vectors corresponding to the same marker conflict with each other. Specifically, in a case where the regulation vectors corresponding to the same marker conflict with each other, as illustrated in FIG. 8, when the inner product of the movement vector 424 and the regulation vector 415 is obtained, the inner product becomes negative, and the occurrence intensity of the AU is determined to be 0. On the other hand, as illustrated in FIG. 10, the determination device 10 may divide the movement vector 424 into the division vectors 444 and 445 according to the determination directions of the respective AUs, and determine the occurrence intensity of the respective AUs.

Furthermore, the processing of dividing the first vector into the second vector and the third vector executed by the determination device 10 includes processing of dividing the first vector into the second vector and the third vector based on the fact that the first vector is a linear sum of the second vector and the third vector.

With this configuration, the determination device 10 may divide the movement vector more easily.

Furthermore, the processing of calculating the first vector executed by the determination device 10 includes processing of correcting distortion of the positions of the markers and calculating the first vector based on the corrected positions of the markers.

With this configuration, the determination device 10 may determine the occurrence intensity of the AU with higher accuracy.

Furthermore, the processing of correcting the distortion of the positions of the markers executed by the determination device 10 includes processing of correcting the distortion of the positions of the markers by using a storage unit that associates first positions of the markers with second positions obtained by correcting the distortion.

With this configuration, the determination device 10 may determine the occurrence intensity of the AU with higher accuracy.

Furthermore, in a case where there is one AU associated with the markers, the determination device 10 further calculates an inner product of the first vector and a vector corresponding to a determination direction of the AU, and determines occurrence intensity of the AU based on the inner product.

With this configuration, the determination device 10 may more efficiently determine the occurrence intensity of the AU.

Furthermore, the determination device 10 further generates data for machine learning based on images obtained by removing the markers from the captured images and the first occurrence intensity and the second occurrence intensity.

With this configuration, it is possible to perform machine learning using the generated data and generate a model for calculating an estimated value of occurrence intensity of an AU from captured images in a case where regulation vectors corresponding to the same marker conflict with each other.

Pieces of information including a processing procedure, a control procedure, a specific name, various types of data, and parameters described above or illustrated in the drawings may be optionally changed unless otherwise noted. Furthermore, the specific examples, distributions, numerical values, and the like described above are merely examples, and may be optionally changed.

Furthermore, each component of each device illustrated in the drawings is functionally conceptual, and does not necessarily have to be physically configured as illustrated in the drawings. In other words, specific forms of distribution and integration of the individual devices are not limited to those illustrated in the drawings. For example, the calculation unit 142 of the determination device 10 may be distributed to a plurality of processing units, or the calculation unit 142 and the division unit 143 of the determination device 10 may be integrated into one processing unit. That is, all or a part of the devices may be configured by being functionally or physically distributed or integrated in optional units according to various loads, use situations, or the like. Moreover, all or an optional part of individual processing functions performed in each device may be implemented by a CPU and a program analyzed and executed by the CPU, or may be implemented as hardware by wired logic.

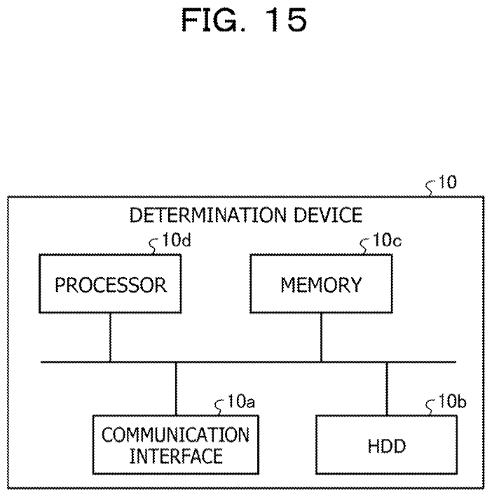

FIG. 15 is a diagram illustrating a hardware configuration example of the determination device according to the present embodiment. As illustrated in FIG. 15, the determination device 10 includes a communication interface 10a, a hard disk drive (HDD) 10b, a memory 10c, and a processor 10d. Furthermore, the respective units illustrated in FIG. 15 are mutually connected by a bus or the like.

The communication interface 10a is a network interface card or the like, and communicates with another server. The HDD 10b stores a program that operates the functions illustrated in FIG. 9 or the like, and a DB.

The processor 10d is a central processing unit (CPU), a micro processing unit (MPU), a graphics processing unit (GPU), or the like. Furthermore, the processor 10d may be implemented by an integrated circuit such as an application specific integrated circuit (ASIC) or a field programmable gate array (FPGA). The processor 10d is a hardware circuit that reads, from the HDD 10b or the like, a program that executes processing similar to that of each processing unit illustrated in FIG. 9 or the like, and loads the read program in the memory 10c to operate a process for executing each function described with reference to FIG. 9 or the like. In other words, this process executes functions similar to those of each processing unit included in the determination device 10.

Furthermore, the determination device 10 may implement functions similar to those of the examples described above by reading the program described above from a recording medium by a medium reading device and executing the read program described above. Note that the program referred to in another example is not limited to being executed by the determination device 10. For example, the present invention may be similarly applied also to a case where another computer or server executes the program, or a case where such a computer and server cooperatively execute the program.

This program may be distributed via a network such as the Internet. Furthermore, this program may be recorded in a computer-readable recording medium such as a hard disk, a flexible disk (FD), a CD-ROM, a magneto-optical disk (MO), or a digital versatile disc (DVD), and may be executed by being read from the recording medium by a computer.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a determination program for causing a computer to execute processing comprising:
acquiring a group of captured images that include a face to which markers are attached;
calculating a first vector based on positions of the markers included in the captured images;
dividing the first vector into a second vector according to a determination direction of a first action unit associated with the markers and a third vector according to a determination direction of a second action unit associated with the markers; and
determining first occurrence intensity of the first action unit and second occurrence intensity of the second action unit based on the second vector and the third vector.

2. The non-transitory computer-readable recording medium according to claim 1, wherein
the processing of dividing includes processing of
dividing the first vector into the second vector and the third vector based on a fact that the first vector is a linear sum of the second vector and the third vector.

3. The non-transitory computer-readable recording medium according to claim 1, wherein
the processing of calculating the first vector includes processing of
correcting distortion of the positions of the markers, and
calculating the first vector based on the corrected positions of the markers.

4. The non-transitory computer-readable recording medium according to claim 3, wherein
the processing of correcting includes processing of
correcting the distortion of the positions of the markers by using a storage unit that associates first positions of the markers with second positions obtained by correcting the distortion.

5. The non-transitory computer-readable recording medium according to claim 1, for causing the computer to further execute processing of,
in a case where there is one action unit associated with the markers, calculating an inner product of the first vector and a vector corresponding to a determination direction of the action unit, and determining occurrence intensity of the action unit.

6. The non-transitory computer-readable recording medium according to claim 1, for causing the computer to further execute processing of
generating training data for machine learning based on images obtained by removing the markers from the captured images and the first occurrence intensity and the second occurrence intensity.

7. A determination device comprising:
a memory; and
a processor coupled to the memory and configured to:
acquire a group of captured images that include a face to which markers are attached;
calculate a first vector based on positions of the markers included in the captured images;
divide the first vector into a second vector according to a determination direction of a first action unit associated with the markers and a third vector according to a determination direction of a second action unit associated with the markers; and
determine first occurrence intensity of the first action unit and second occurrence intensity of the second action unit based on the second vector and the third vector.

8. A determination method comprising:
acquiring a group of captured images that include a face to which markers are attached;
calculating a first vector based on positions of the markers included in the captured images;
dividing the first vector into a second vector according to a determination direction of a first action unit associated with the markers and a third vector according to a determination direction of a second action unit associated with the markers; and
determining first occurrence intensity of the first action unit and second occurrence intensity of the second action unit based on the second vector and the third vector.
